(19) United States
(12) Patent Application Publication
(10) Pub. No.: US 2025/0317575 A1
(43) Pub. Date: Oct. 9, 2025

(54) METHODS AND APPARATUS FOR INCORPORATING TEMPORAL ENTRIES FOR INTRA PREDICTION MODE

(71) Applicant: Alibaba (China) Co., Ltd., Hangzhou (CN)

(72) Inventors: Xinwei LI, Beijing (CN); Ru-ling LIAO, Sunnyvale, CA (US); Jie CHEN, Beijing (CN); Yan YE, San Diego, CA (US)

(21) Appl. No.: 19/088,291

(22) Filed: Mar. 24, 2025

Related U.S. Application Data
(60) Provisional application No. 63/631,044, filed on Apr. 8, 2024.

(51) Int. Cl. H04N 19/159; H04N 19/176

(52) U.S. Cl. CPC H04N 19/159; H04N 19/176

(57) ABSTRACT

A method of decoding a bitstream to output one or more pictures for a video stream. The method includes receiving a bitstream; and decoding, using coded information of the bitstream, one or more pictures. The decoding includes obtaining temporal information for an intra prediction mode from an encoded picture; and decoding a current block based on the temporal information, wherein the temporal information associated with one or more positions in the encoded picture.

### CROSS-REFERENCE TO RELATED APPLICATIONS

The disclosure claims the benefits of priority to U.S. Provisional Application No. 63/631,044, filed Apr. 8, 2024, which is incorporated herein by reference in its entirety.

### TECHNICAL FIELD

The present disclosure generally relates to video processing, and more particularly, to methods and apparatuses for incorporating temporal components into intra prediction.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a method of decoding a bitstream to output one or more pictures for a video stream. The method includes receiving a bitstream; and decoding, using coded information of the bitstream, one or more pictures. The decoding includes obtaining temporal information for an intra prediction mode from an encoded picture; and decoding a current block based on the temporal information, wherein the temporal information associated with one or more positions in the encoded picture.

Embodiments of the present disclosure provide a method of encoding a video sequence into a bitstream. the method includes receiving a video sequence; encoding one or more pictures of the video sequence, wherein the encoding comprises; and generating a bitstream based on the encoding. The encoding includes obtaining temporal information for an intra prediction mode from an encoded picture; and encoding a current block based on the temporal information, wherein the temporal information associated with one or more positions in the encoded picture.

Embodiments of the present disclosure provide a non-transitory computer readable storage medium storing a set of instructions that are executable by one or more processors of a system to cause the system to perform operations for generating a bitstream, the operations includes receiving a video sequence; encoding one or more pictures of the video sequence by: obtaining temporal information for an intra prediction mode from an encoded picture; and encoding a current block based on the temporal information, wherein the temporal information associated with one or more positions in the encoded picture; and generating a bitstream based on the encoding.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 is a schematic diagram illustrating exemplary reference samples used in a planar mode, according to some embodiments of the present disclosure.

FIG. 6 is a schematic diagram illustrating 67 intra prediction modes, according to some embodiments of the present disclosure.

FIG. 7 is a schematic diagram illustrating an exemplary matrix weighted intra prediction process, according to some embodiments of the present disclosure.

FIG. 8 is a schematic diagram illustrating an exemplary template for template-based intra mode derivation (“TIMD”), according to some embodiments of the present disclosure.

FIG. 9 is a schematic diagram illustrating exemplary samples used for calculating gradients for decoder side intra mode derivation (DIMD), according to some embodiments of the present disclosure.

FIG. 10 is a schematic diagram illustrating exemplary adjacent blocks used in for deriving a general intra most probable modes (MPM) list, according to some embodiments of the present disclosure.

FIG. 11 is a schematic diagram illustrating a collocated block position of temporal motion in VVC, according to some embodiments of the present disclosure.

FIG. 12 illustrates a flow chart showing an example method using information of blocks in collocated picture for intra prediction mode, according to some embodiments of the present disclosure.

FIG. 13 is a schematic diagram illustrating exemplary temporal positions in a collocated picture, according to some embodiments of the present disclosure.

FIG. 14 is a schematic diagram illustrating exemplary shifted temporal positions in a collocated picture, according to some embodiments of the present disclosure.

FIG. 15 is a schematic diagram illustrating exemplary positions for selecting the neighboring motion vector, according to some embodiments of the present disclosure.

FIG. 16 illustrates a flow chart showing an example method using information of blocks in collocated picture for TIMD merge list mode, according to some embodiments of the present disclosure.

FIG. 17 illustrates a flow chart showing an example method using information of blocks in collocated picture for DIMD merge mode, according to some embodiments of the present disclosure.

FIG. 18 illustrates a flow chart showing an example method using information of blocks in collocated picture for DIMD merge mode, according to some embodiments of the present disclosure.

FIGS. 19A-19C are schematic diagrams illustrating inclusion orders of entries in a DIMD merge list, according to some embodiments of the present disclosure.

FIG. 20 illustrates a flow chart showing an example method using information of blocks in collocated picture for OBIC mode, according to some embodiments of the present disclosure.

FIG. 21 illustrates a flow chart showing an example method using information of blocks in collocated picture for MPM, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recent and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

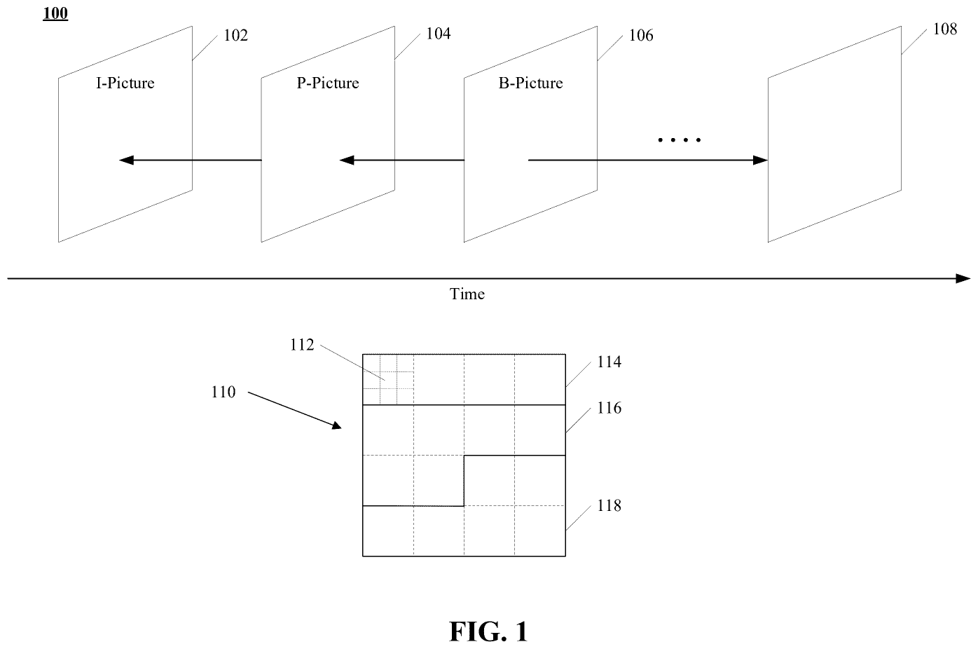

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

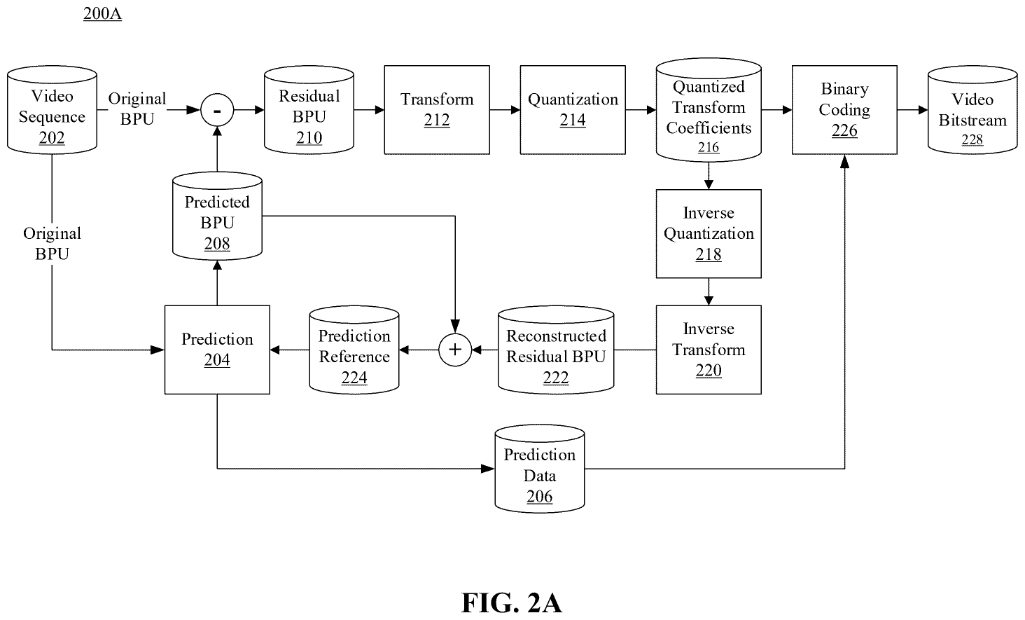

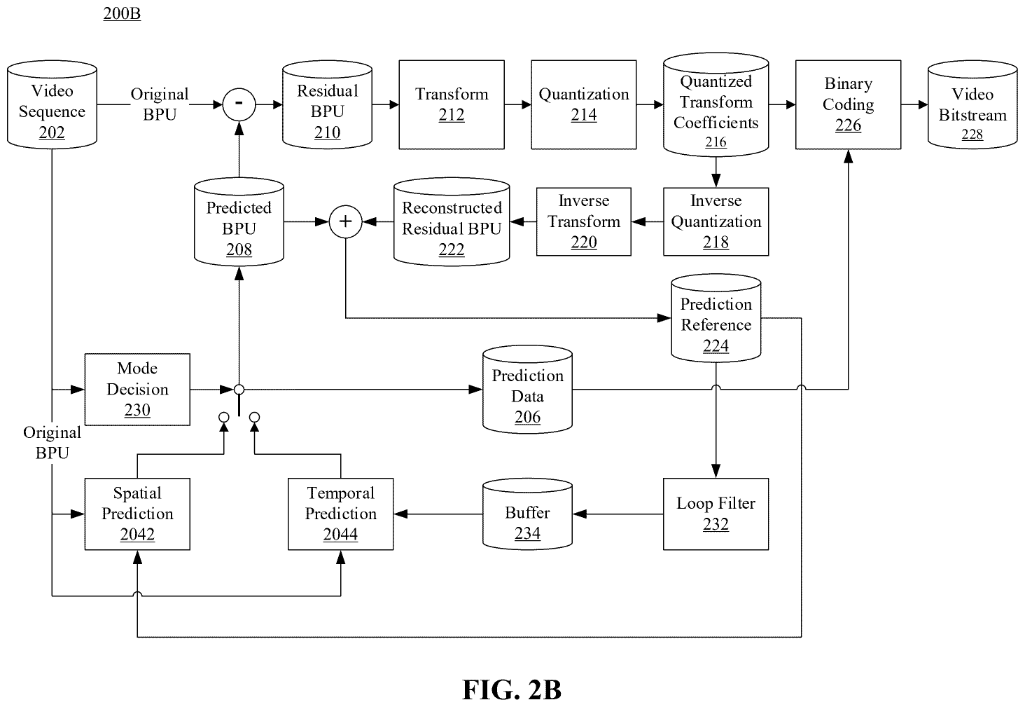

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

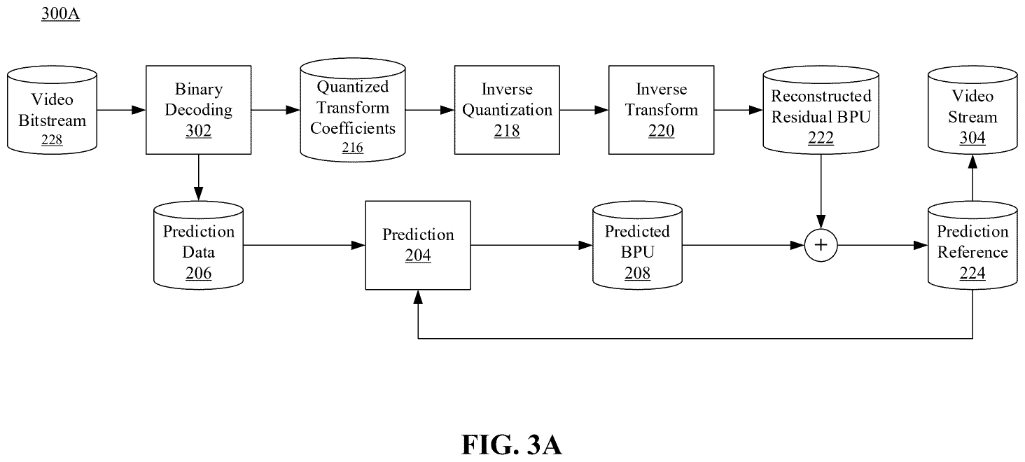

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

After the VVC standard is finalized and is published as an international standard, the JVET starts exploring new coding tools to further improve the coding performance of the VVC standard. Enhanced Compression Model (ECM) is proposed and has been used as new software base for developing tools beyond the VVC standard.

According to the VVC standard, multiple intra prediction modes can be used to predict the current block. These modes include traditional modes (a Planar intra prediction mode, a direct coding (DC) intra prediction mode, and an angular intra prediction mode), a Matrix based intra prediction mode (MIP), and an intra block copy mode (IBC).

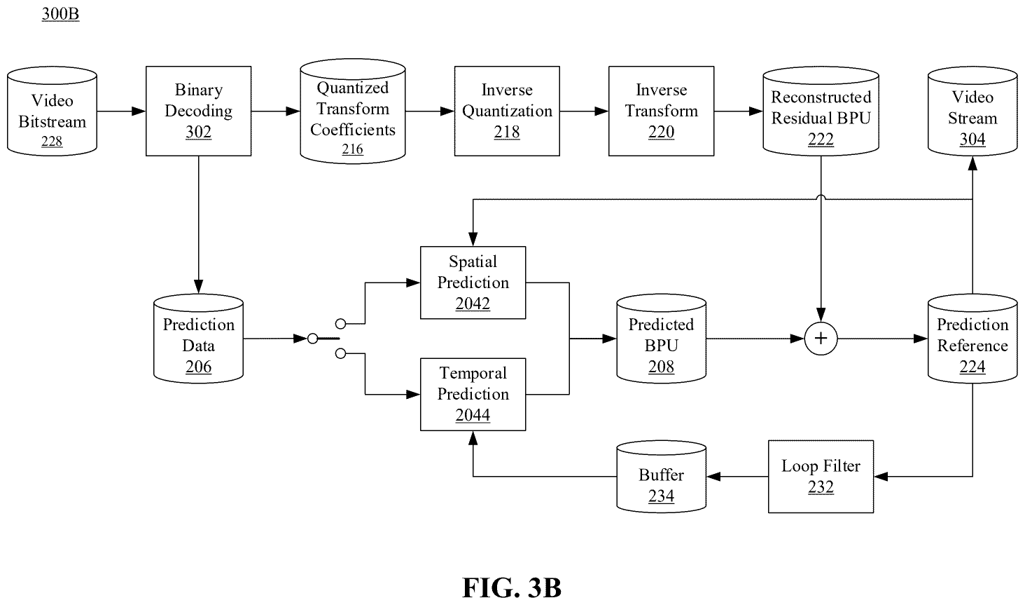

According to the planar mode, predicted value of the current sample is obtained from reconstructed values of four reference samples: the left reference sample in the same row as the current sample, the above reference sample in the same column as the current sample, the reference sample on the bottom-left position adjacent to the current block and the reference sample on the top-right position adjacent to the current block. FIG. 5 is a schematic diagram illustrating exemplary reference samples used in a planar mode, according to some embodiments of the present disclosure. For example, using pred (x,y) to represent the predicted value of the current sample, using H to represent the height of the current block, and using W to represent the width of the current block, the reconstructed values of the four reference samples used in planar mode can be respectively represented as rec(−1,y), rec(x,−1), rec(−1,H) and rec(W,−1), where (x,y) represents the coordinate positions of the current sample relative to the top-left position within the current block.

The planar mode generates the predicted value of the current sample according to Equations 1, 2, and 3 below. In Equation 1, an intermediate value predV(x,y) is obtained from rec(x,−1) and rec(−1,H). In Equation 2, another intermediate value predH(x,y) is obtained from rec(−1,y) and rec(W,−1). The two intermediate values are used to generate the predicted value of the current sample according to Equation 3. Planar mode can be represented as index 0.

$$predV ( x , y ) = ( ( H - 1 - y ) * r e c ( x , - 1 ) + ( y + 1 ) * r e c ( - 1 , H ) ) << {log}_{2} W \qquad ( 1 )$$

$$redH ( x , y ) = ( ( W - 1 - x ) * r e c ( - 1 , y ) + ( x + 1 ) * r e c ( W , - 1 ) ) << \_ 2 H \# ) \qquad ( 2 )$$

$$pred ( x , y ) = ( pred V ( x , y ) + pred H ( x , y ) + W * H ) >> ( {2}_{} W + {log}_{\text{?}} \qquad ( 3 )$$

$$\text{?} \text{indicates text missing or illegible when filed}$$

1) rovides two additional planar modes where only the horizontal interpolation or only the vertical interpolation are used to obtain the predicted samples for luma.

For the planar horizontal mode, only the horizontal linear interpolation is performed based on the left reference sample and the top-right reference sample to predict the current sample by Equation 4 below:

$$pred ( x , y ) = ( ( W - 1 - x ) * r e c ( - 1 , y ) + ( x + 1 ) * r e c ( W , - 1 ) + ( W >> 1 ) ) >> {log}_{2} ( W )$$

For the planar vertical mode, only the vertical linear interpolation is performed based on the above reference sample and the bottom-left reference sample to predict the current sample by Equation 5 below:

$$pred ( x , y ) = ( ( H - 1 - y ) * r e c ( x , - 1 ) + ( y + 1 ) * r e c ( - 1 , H ) + ( H >> 1 ) ) >> {log}_{2} ( H )$$

According to the DC mode, an average value of the left and above reference samples to the current block is used for prediction generation. In HEVC, every intra-coded block has a square shape and the length of each of its side (i.e., left and above) is a power of 2. Thus, no division operations are required to calculate the average value. In contrast, according to VVC, blocks can have a rectangular shape that necessitates the use of a division operation per block in the general case. To avoid division operations for DC prediction, only the longer side is used to compute the average value for non-square blocks. For square blocks, reference samples from both left and above sides are used to compute the average value. DC mode can be represented as index 1.

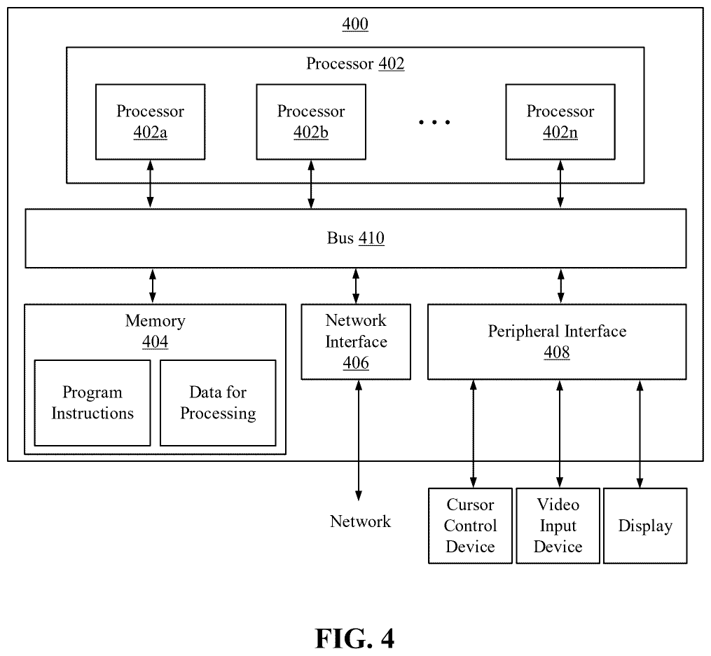

Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 6 is a schematic diagram illustrating 67 intra prediction modes, according to some embodiments of the present disclosure. The new angular intra prediction modes not in HEVC are depicted as broken lines in FIG. 6. The 65 angle modes can be represented as index 2 to index 66 from bottom left to top right.

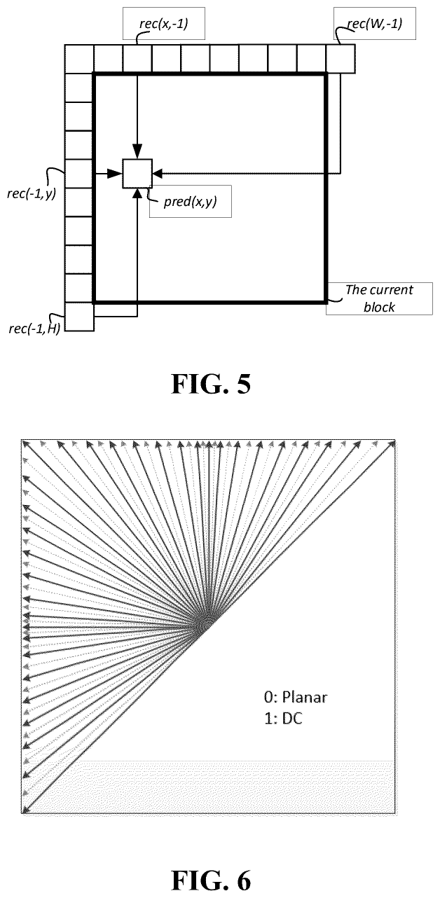

In the MIP mode, for predicting the samples of a block of width W and height H, MIP takes one line of H reconstructed neighboring boundary samples left of the block and one line of W reconstructed neighboring boundary samples above the block as input. FIG. 7 is a schematic diagram illustrating an exemplary matrix weighted intra prediction process, according to some embodiments of the present disclosure. As shown in FIG. 7, the generation of the prediction signal is based on the following three steps, which are a down-sampling of the reference samples, a matrix vector multiplication, and an up-sampling of the result by linear interpolation. In some cases, the down-sampling can be realized by averaging.

In the IBC mode, it significantly improves the coding efficiency of screen content materials. Since IBC mode is implemented as a block level coding mode, block matching (BM) is performed at the encoder to find the optimal block vector (or motion vector) for each CU. A block vector is used to indicate the displacement from the current block to a reference block, which is already reconstructed inside the current picture. The luma block vector of an IBC-coded CU is in integer precision. The chroma block vector rounds to integer precision as well.

The ECM proposal further implements intra prediction modes beyond those provided by the VVC standard, including a spatial geometric partition mode (SGPM), intra template matching (intra TMP), a template-based intra mode derivation (“TIMD”) mode and a decoder-side intra mode derivation (“DIMD”) mode.

In the SGPM mode, the current block is split into two parts, and two intra prediction modes are used to predict the two parts respectively. In this mode, a candidate list is built with each entry containing one partition split mode and two traditional intra prediction modes. In total 26 partition split modes and 9 of traditional intra prediction modes are used to form the combinations. The length of the candidate list is set equal to 16. The selected entry index is signaled into the bitstream.

Intra TMP mode is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. A block vector that indicates the displacement from the current block to the corresponding block is stored.

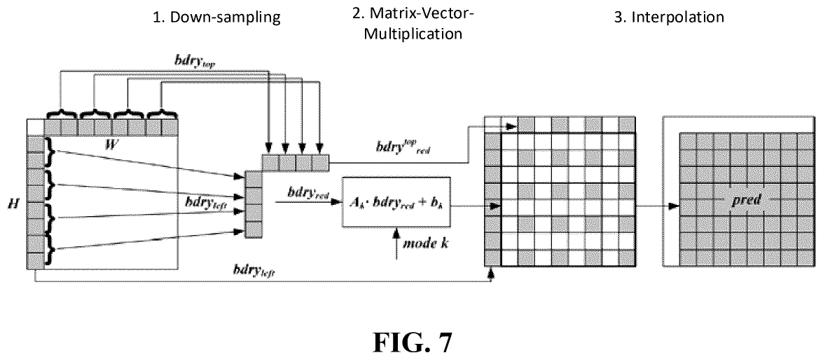

Template-based intra mode derivation (TIMD) is also used in the disclosed embodiments. According to some TIMD embodiments, the prediction modes used to predict the current block are derived based on a template of the current block. First, an intra prediction mode list is constructed which includes some of the traditional intra prediction modes (planar mode, DC mode, and angular modes). For each intra prediction mode in the list, the Sum of Absolute Transformed Difference (SATD) between the prediction and reconstruction samples of the template is calculated. The prediction samples of the template are generated using the reference samples of the template. FIG. 8 is a schematic diagram illustrating an exemplary template for template-based intra mode derivation (“TIMD”), according to some embodiments of the present disclosure. As shown in FIG. 8, the template includes samples in the above and left of the current block. The first two intra prediction modes with the minimum SATD and one non-angular intra prediction mode (e.g., DC mode or Planar mode) with the lowest SATD cost are selected as the TIMD modes. These three TIMD modes are fused with the weights to generate the final predicted samples of the current block. The number of the angular modes in the TIMD list are further extended to 129.

The conditions below are checked to determine whether the non-angular intra prediction mode is used in fusion: 1) the non-angular intra prediction mode is different from the first two selected intra prediction modes; and 2) costMode3<1.5×costMode1, where the costMode3 is the SATD cost of the non-angular intra prediction mode and costMode1 is the SATD cost of the first selected intra prediction mode.

If both of the conditions are true, three intra prediction modes are used to generate the prediction. And the weights of each intra prediction mode are computed from SATD cost as

### Equation 6:

$${weight}_{i} = \frac{sumSATD - {costMode}_{i}}{2 \times sumSATD} , sumSATD = {\sum }_{j = 1}^{3} {costMode}_{i}$$

Otherwise, the non-angular intra prediction mode is not used in prediction. And the costs of the two selected modes are compared with a threshold as: costMode2<2×costMode1, where the costMode2 is the SATD cost of the second selected intra prediction mode. If this condition is true, the fusion is applied to the two selected modes with the weights as calculated as Equation 7 and Equation 8. Otherwise, only the first selected mode is used to predict the current block.

$${weight}_{1} = \frac{costMode 2}{costMode 1 + costMode 2} \qquad ( 7 )$$

$${weight}_{2} = 1 - {weight}_{1} \qquad ( 8 )$$

The division operations are replaced by right shifting operations using a lookup table (LUT) based scheme.

Besides, location-dependent sample-based fusion process is used for the TIMD fusion where the location-dependent criterion applying to the selected predictors is calculated based on SATD. The location-dependent criterion is determined from a ratio of the normalized SATD of the selected TIMD predictors computed in above and left template area.

According to some TIMD embodiments, a TIMD merge list mode is applied to predict the current block, where the TIMD modes and their weights can be inherited from the previously TIMD coded blocks. First, the adjacent and non-adjacent spatial neighboring blocks are scanned and if the scanned block is coded based on TIMD or TIMD merge list mode, and added to a block list. Then the blocks in the block list are sorted by a block distance to the current block. The block distance is calculated as the sum of the absolute horizontal distance and the absolute vertical distance from an adjacent block or a non-adjacent block to the current block (from the top-left position of the adjacent block to the top-left position of the current block). The TIMD information (including the prediction modes and their fusion weights) of up to the first N1 blocks with the shortest block distance in the block list will be added to a TIMD merge list. A redundancy check (pruning stage) is applied so that a TIMD merge list entry is added to the TIMD merge list when the associated TIMD information is different from every TIMD information from TIMD merge list entry already present in the list.

After forming the TIMD merge list, the list entries are sorted based on the SATD cost over the template of the current block. For each list entry, the template is predicted by the prediction modes of the entry respectively and fused by the fusion weights of the list entry to generate the predicted samples of the template. The template size and the template cost calculation aspects are the same as in TIMD mode. After sorting the TIMD merge candidates, the best N2 TIMD merge list entries that has the smallest SATD cost are saved.

A flag is signaled to indicate whether the TIMD merge list mode is applied to the current block and an index is further signaled if N2 is larger than 1 to indicate which TIMD merge list entry is used to predict the current block. In some embodiments, the flag is conditional signaled if at least one of the adjacent and non-adjacent blocks is coded based on TIMD mode or TIMD merge list mode. Decoder side intra mode derivation (DIMD) used in the disclosed embodiments is described. According to some DIMD embodiments, the prediction modes used to predict the current block are derived based on gradients information. When DIMD mode is applied, up to five angular modes are derived from the reconstructed neighbor samples, and those five predictors are combined with a non-angular predictor with the weights derived from a histogram of gradients (HoG).

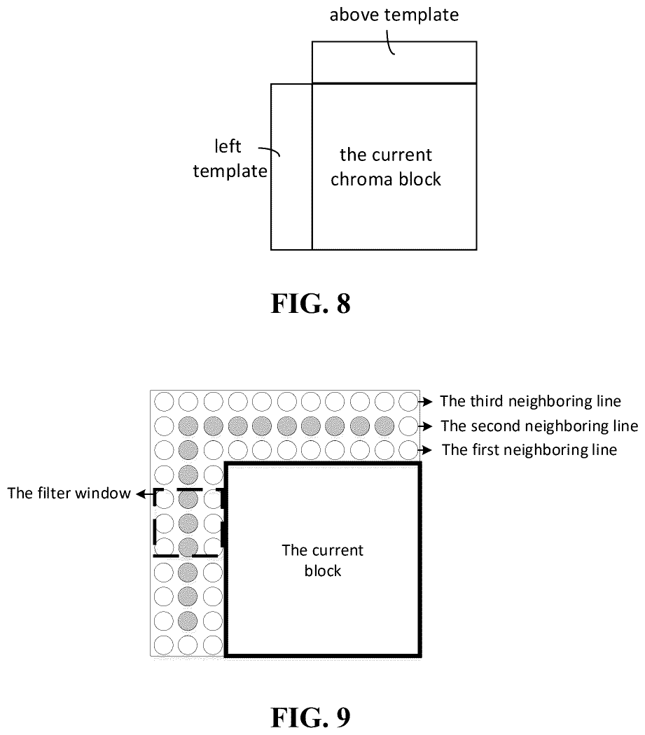

FIG. 9 is a schematic diagram illustrating exemplary samples used for calculating gradients for decoder side intra mode derivation (DIMD), according to some embodiments of the present disclosure. To build the DIMD HoG for a block, a gradient analysis is performed on the samples of a L-shaped template of the second neighboring line surrounding the block, which are depicted as grey circles in FIG. 9. For each available reconstructed sample of the template, a horizontal gradient and a vertical gradient, Gx and Gy, are carried out by applying horizontal and vertical Sobel filters as follows:

$${F}_{h o r} = [ \begin{matrix}1 & 0 & - 1 \\ 2 & 0 & - 2 \\ 1 & 0 & - 1\end{matrix} ] and {F}_{v e r} = [ \begin{matrix}- 1 & - 2 & - 1 \\ 0 & 0 & 0 \\ 1 & 2 & 1\end{matrix} ] \qquad ( 9 )$$

For each sample in the template, for which the horizontal gradient Gx and the vertical gradient Gy are calculated, the intensity (G) and the orientation (O) of the gradients are further calculated using Gx and Gy as follows:

$$G = \vert {G}_{x} \vert + \vert {G}_{y} \vert \qquad ( 10 )$$

$$O = atan ( \frac{{G}_{y}}{{G}_{x}} ) \qquad ( 11 )$$

The orientation of the gradients O is then converted into the closest angular mode, used to index a HoG which is first initialized to zero. And the HoG value at that angular mode is increased by G. Once all the samples in the template have been processed, the HoG will contain cumulative values of gradient intensities for each angular mode. Up to five angular modes with the highest amplitude values in the HoG are selected.

The division operations in weight derivation are performed utilizing a lookup table (LUT) based scheme. For example, the division operation in the orientation calculation as shown in Equation 11 is computed by the following LUT-based scheme:

$$x = Floor ( Log 2 ( G x ) ) \qquad ( 12 )$$

$$normDiff = ( ( Gx << 4 ) >> x ) \& 15$$

$$x += ( 3 + ( normDiff != 0 ) ? 1 : 0 )$$

$$\frac{{G}_{y}}{{G}_{x}} = ( Gy * ( DivSigTable [ normDiff ] \vert 8 ) + ( 1 << ( x - 1 ) ) ) >> x \qquad ( 13 )$$

$$where$$

$$DivSigTable [ 16 ] = \{ 0 , 7 , 6 , 5 , 5 , 4 , 4 , 3 , 3 , 2 , 2 , 1 , 1 , 1 , 1 , 0 \}$$

A prediction fusion is applied as a weighted average of the selected angular modes and the non-angular mode predictors. The weight of the non-angular mode is a fixed value. The remaining weight is then shared between the selected angular modes, proportionally to their amplitude values which can be represented as wDimdi.

For a block of size W×H, the weight for each of the five derived modes is modified if one of the above or left HoG amplitudes is twice larger than the other one. In this case, the weights are location dependent and computed as follows:
If the above HoG is twice the left, then:

$${w}_{i} ( x , y ) = {wDimd}_{i} + {Δ}_{i} - 2 {Δ}_{i} \frac{y}{( H - 1 )} . \qquad ( 14 )$$

If the left HoG is twice the above, then:

$${w}_{i} ( x , y ) = {wDimd}_{i} + {Δ}_{i} - 2 {Δ}_{i} \frac{x}{( w - 1 )} , \qquad ( 15 )$$

where Δi is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the adjacent blocks.

According to some DIMD embodiments, the region of neighboring reconstructed samples used for computing the histogram of gradients is modified depending on reconstructed samples availability. The region of decoded reference samples of current W×H block is extended towards the above-right side if available, up to W additional columns and extended towards the bottom-left side if available, up to H additional rows.

According to some DIMD embodiments, a DIMD merge mode is applied to predict the current block based on the computation of a merged histogram of gradients (MHoG). Similar to DIMD, up to five angular modes are derived from the MHoG and are then fused together with a non-angular mode to generate the predicted samples of the current block. The derivation of the modes and fusion weights follows the same process to derive DIMD modes and fusion weights from the HoG. But differently than DIMD, the MHoG is not computed directly analyzing the template samples, but is computed based on information extracted from adjacent blocks.

The adjacent blocks coded using DIMD mode or DIMD merge mode are considered in building the MHoG. The HoG or MHoG of each adjacent block is directly considered as Hᵢ, where Hᵢ(m) refers to the amplitude of angular mode m in the HoG, where m can take values from 0 to M where M is the maximum number of angular modes.

According to some DIMD embodiments, the adjacent blocks coded with at least one angular mode are considered in building the MHoG. In case the adjacent block i is coded using DIMD mode or DIMD merge mode, then its HoG or MHoG is directly considered as Hᵢ, where Hᵢ(m) refers to the amplitude of angular mode m in the HoG, where m can take values from 0 to M where M is the maximum number of angular modes. A normalisation process can be used when considering Hᵢ. In case the adjacent block i is instead coded using one angular mode m, then a HoG Hᵢ is derived for that adjacent block, where Hᵢ(k)=0 for k=0, 1, . . . . M, k≠m and Hᵢ(m)=A, where the value A depends on the size of the current block. In case the adjacent block i is coded using SGPM or TIMD where more than one angular intra prediction modes may be used to predict the adjacent block, all these angular modes can be considered in the derivation of Hᵢ.

Then, the MHoG Ã can be computed using all the HoGs extracted from considered adjacent blocks as the following equation, where N3 is the number of the blocks considered in building the MHoG.

$$\tilde{H} ( m ) = \frac{{\sum }_{i = 0}^{N 3 - 1} {H}_{i} ( m )}{N 3} \qquad ( 16 )$$

Finally, the MHoG is used to derive the angular modes and weights. The angular modes and their weights corresponding to the five highest amplitudes in the MHOG are selected to predict the current block.

A flag is signaled to indicate whether the DIMD merge mode is applied to the current block if at least one of the adjacent blocks is coded based on at least one angular mode.

According to some DIMD embodiments, the adjacent blocks are sorted based on the block distance to the current block, and up to the first N4 blocks with the shortest block distance are considered in building the MHOG if it is coded with at least one angular mode.

According to some DIMD embodiments, the non-adjacent blocks can also be considered in building the MHOG of the DIMD merge mode.

According to some DIMD embodiments, in case the adjacent block i is coded based on an inter mode, then an intra mode is derived based on the motion information and this intra mode can be considered in building the MHOG if this derived intra mode is an angular mode.

According to some DIMD embodiments, a DIMD merge list mode is applied to predict the current block, where the DIMD modes and their weights can be inherited from the previously DIMD mode coded blocks or DIMD merge list mode coded blocks. The adjacent and non-adjacent spatial neighboring blocks are scanned in a fixed order and if the scanned block is coded based on DIMD mode or DIMD merge list mode, the DIMD information (including the prediction modes and their weights) are added to a DIMD merge list. The DIMD merge list can contain up to 5 entries. A redundancy check (pruning stage) is applied so that a DIMD merge list entry is added to the DIMD merge list when the associated DIMD information is different from every DIMD information from DIMD merge list entry already present in the list and the DIMD information derived by the DIMD HoG of the current block.

A flag is signaled to indicate whether the DIMD merge list mode is applied to the current block and an index is further signaled to indicate which DIMD merge list entry is used to predict the current block. The flag is conditional signaled if at least one of the adjacent and non-adjacent blocks is coded based on DIMD mode or DIMD merge list mode.

According to some DIMD embodiments, the DIMD information from the DIMD merge mode can be an entry is the DIMD merge list.

Occurrence-based intra coding (OBIC) used in the disclosed embodiments is described. According to an ECM proposal, an occurrence-based intra coding (OBIC) mode can be applied to predict the current block. The OBIC mode derives the intra prediction modes of the current block based on the sample-wise occurrence of the intra modes in the spatial adjacent blocks of the current block. For this, adjacent and non-adjacent spatial neighboring blocks are checked and the intra prediction modes of the blocks are collected into an occurrence histogram. Instead of Histogram of Gradient (HoG) as in DIMD, the OBIC introduces the Histogram of occurrence (HoC), which consists of the intra modes and their sample-wise occurrences. The occurrence values are calculated based on the number of samples that are coded based on a certain intra prediction mode in that neighborhood. For example, if a W x H adjacent or non-adjacent block is coded with an IPM mode, the occurrence of the mode in that particular block is calculated based on:

$$HoC [ IPM ] += W \times H \qquad ( 17 )$$

Up to 5 angular modes with the highest occurrence are selected from the HoC and used for final prediction by fusing the predictors of the selected angular modes and a non-angular mode like DIMD mode.

For an adjacent or non-adjacent block using more than one intra mode for prediction, all the prediction modes are selected and used when creating the OBIC histogram, like SGPM mode, TIMD mode. Moreover, the intra modes of an adjacent or non-adjacent blocks, that has no angular mode, planar mode, or DC mode, are not considered when creating the histogram of OBIC mode, like MIP mode, IBC mode and intra TMP mode.

The fusion weights are calculated similar to the DIMD mode, but instead of using gradient values from the template, the occurrence values are used for OBIC.

A flag is signaled to indicate whether the OBIC mode is applied to the current block if at least one of the adjacent and non-adjacent blocks is coded based on one of the angular modes, planar mode, and DC mode.

Most probable mode (MPM) used in the disclosed embodiments is described. According to the VVC standard, to keep the complexity of the most probable mode (MPM) list generation low, an intra mode coding method with 6 MPMs is used by considering two available neighboring intra modes.

A unified 6-MPM list is used for intra blocks. The MPM list is constructed based on intra modes of the left and above adjacent blocks. Suppose the mode of the left is denoted as Left and the mode of the above block is denoted as Above, the unified MPM list is constructed as follows:
When an adjacent block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max−Min is equal to 2:
      MPM list→{Planar, Left, Above, Min+1, Min−1, Max+1}
   Otherwise:
      MPM list→{Planar, Left, Above, Min−1,−Min+1, Max−1}
If Left and Above are both angular and they are the same:
   MPM list→{Planar, Left, Left−1, Left+1, Left−2, Left+2}

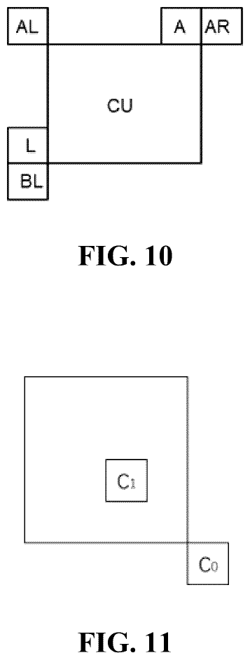

According to the ECM proposal, secondary MPM lists are introduced. FIG. 10 is a schematic diagram illustrating exemplary adjacent blocks used in for deriving a general intra most probable modes (MPM) list, according to some embodiments of the present disclosure. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) adjacent blocks as shown in FIG. 10, and DIMD modes which are sorted in ascending order of SAD cost. Up to 5 modes with the smallest SAD cost are added. The SAD cost is computed between the prediction and the reconstruction samples of the template. The sorted directional modes with added offset are added into the general MPM list, and then the default modes, until the general MPM list with 22 entries is constructed.

If a block is vertically oriented, the order of neighboring blocks is A, L, BL, AR, AL; otherwise, it is L, A, BL, AR, AL.

According to the ECM proposal, the intra modes of the non-adjacent blocks can also be added to the MPM list. And the MPM list is sorted by applying the intra prediction mode of each entry to a template of the current block and calculating the sum of absolute difference (SAD) values between predicted samples and reconstructed samples of the template.

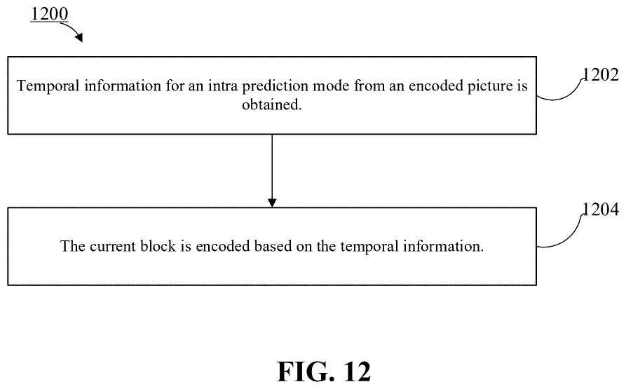

Collocated picture used in temporal motion is described. In VVC, temporal motion is used as one of candidates for merge and AMVP mode in inter coding. FIG. 11 is a schematic diagram illustrating a collocated block position of temporal motion in VVC, according to some embodiments of the present disclosure. As shown in FIG. 11, the temporal motion is derived from a collocated picture and is obtained from bottom-right or center of the collocated block. Basically, only one collocated picture is allowed in VVC. This collocated picture is selected at encoder and is signaled in picture and slice header in the bitstream.

In ECM, to further improve the prediction accuracy of temporal motion, another collocated picture is introduced. Two collocated pictures are utilized which are the two reference frames with the least POC distance relative to the current frame.

During the implementation of the above intra prediction modes, the following problems are observed. Specifically, in the design of TIMD merge list mode, DIMD merge mode, DIMD merge list mode, OBIC mode, and MPM list construction, only the corresponding information from spatial adjacent or non-adjacent blocks are considered. Therefore, to further improve the accuracy and richness, a method considering corresponding information from temporal blocks in the collocated picture is needed.

To solve one or more of the above-described problems, embodiments of the present disclosure provide methods of using temporary information from blocks (also referred as positions) in a collocated picture of the current block for intra prediction.

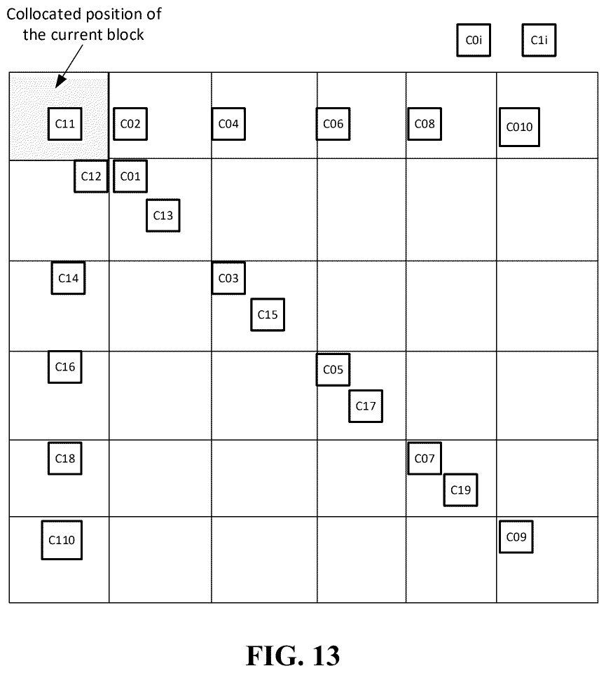

FIG. 12 illustrates a flow chart showing an example method using information of blocks in collocated picture for intra prediction mode, according to some embodiments of the present disclosure. Method 1200 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1200. In some embodiments, method 1200 can be implemented by a computer program product, embodied in a computer-readable medium, including computer-executable instructions, such as program code, executed by computers (e.g., apparatus 400 of FIG. 4). Referring to FIG. 12, method 1200 may include the following steps 1202 and 1204.

At step 1202, temporal information for an intra prediction mode from an encoded picture is obtained. The intra prediction mode can be a TIMD mode, a TIMD merge list mode, a DIMD mode, a DIMD merge mode, a OBIC mode, or a MPM. The temporal information is associated with one or more positions (or blocks) in the encoded picture. In some embodiments, the encoded picture is a collocated picture of a current block. In some embodiments, the one or more positions in the collocated picture includes temporal positions and shifted temporal positions. The temporal positions are selected from the collocated picture, and the shifted temporal positions are also selected from the collocated picture and obtained by shifting one temporal position with an adjacent motion vector.

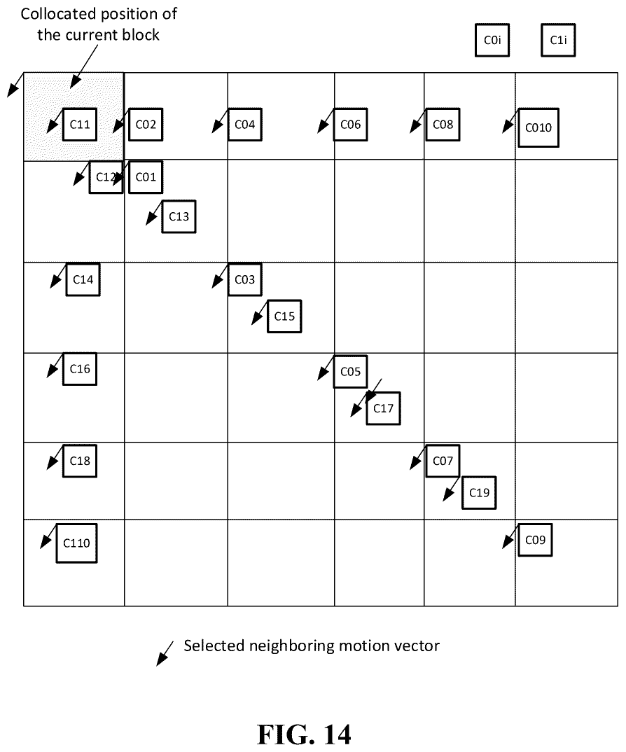

FIG. 13 is a schematic diagram illustrating exemplary temporal positions in a collocated picture, according to some embodiments of the present disclosure. As shown in FIG. 13, an example of inclusion order of the temporal candidates is as follows: C01→C02→ . . . →C010. If C0i is not available (i.e., the position of C0i is outside of picture/slice boundary or outside of the current CTU row) and C1i is available, C1i will be used to replace C0i, where 1≤i≤10. If neither C0i nor C1i is available, the next inclusion position is checked.

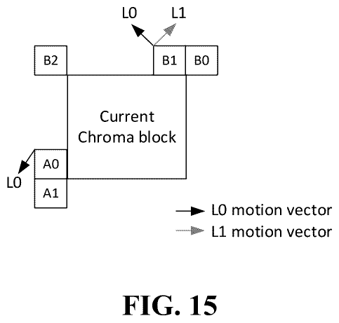

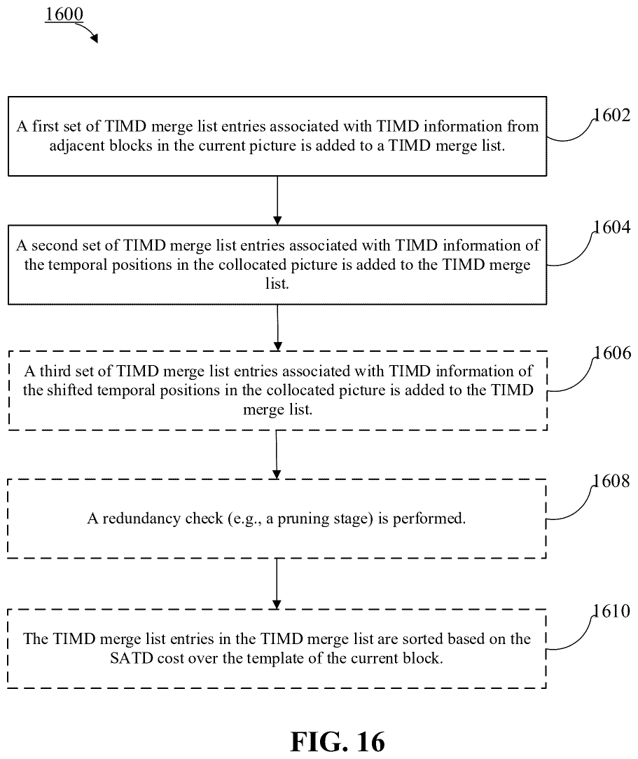

FIG. 14 is a schematic diagram illustrating exemplary shifted temporal positions in a collocated picture, according to some embodiments of the present disclosure. In one example, as shown in FIG. 14, the temporal position is shifted by a selected adjacent motion vector (also referred as neighboring motion vector). Consequently, the positions of C0i and C1i are shifted by the same adjacent motion vector. The inclusion order of shifted temporal positions is the same as that of temporal positions. FIG. 15 is a schematic diagram illustrating exemplary positions for selecting the neighboring motion vector, according to some embodiments of the present disclosure. The adjacent motion vector is selected from the motion vectors of the adjacent blocks as depicted in FIG. 15. The checking order is as follows: L0B1→L1B1→L0A1→L1A1→L0B0→L1B0→L0A0→L1A0→L0B2→L1B2. The first motion vector that uses the collocated picture as the reference picture is selected. If there is no such motion vector found, there will be no TIMD information associated with the shifted temporal position to be obtained. It can be understood that the positions in a block shown in FIGS. 13 and 14 are only for illustration purposes, it could be other positions in the block. The directions of motion vectors shown in FIGS. 14 and 15 are only for illustration purposes, it could be other directions.

Referring back to FIG. 12, at step 1204, the current block is processed based on the temporal information. Therefore, the temporal information can be used in intra prediction modes thereby improving the accuracy and richness of the video processing.

According to exemplary embodiments consistent with the present disclosure, when TIMD list mode or TIMD merge list mode is applied, TIMD information of blocks in the collocated picture can be added to the TIMD merge list.

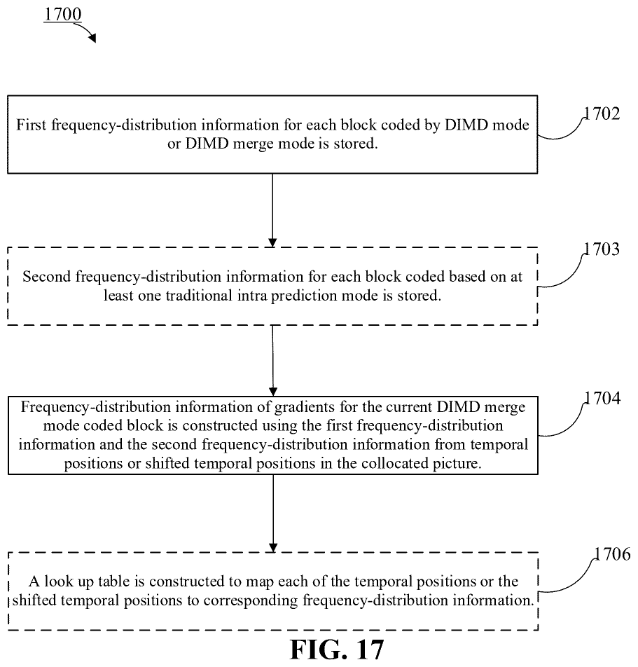

FIG. 16 illustrates a flow chart showing an example method using information of blocks in collocated picture for TIMD merge list mode, according to some embodiments of the present disclosure. Method 1600 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1600. In some embodiments, method 1600 can be implemented by a computer program product, embodied in a computer-readable medium, including computer-executable instructions, such as program code, executed by computers (e.g., apparatus 400 of FIG. 4). Referring to FIG. 16, method 1600 may include the following steps 1602 and 1604.

At step 1602, a first set of TIMD merge list entries associated with TIMD information from adjacent blocks in the current picture is added to a TIMD merge list. TIMD information includes the prediction mode and the fusion weights. In some embodiments, a set of TIMD merge list entries associated with TIMD information from non-adjacent blocks in the current picture is also added to the TIMD merge list.

At step 1604, a second set of TIMD merge list entries associated with TIMD information of the temporal positions in the collocated picture is added to the TIMD merge list.

In some embodiments, method 1600 further includes step 1606. At step 1606, a third set of TIMD merge list entries associated with TIMD information of the shifted temporal positions in the collocated picture is added to the TIMD merge list. In some embodiments, referring to FIG. 15, if there is no motion vector found, the corresponding TIMD information entries of shifted temporal positions is not added to the TIMD merge list.

In some embodiments, method 1600 further includes step 1608. At step 1608, a redundancy check (e.g., a pruning stage) is performed, so that a TIMD merge list entry is added to the TIMD merge list when the associated TIMD information is different from every TIMD information from TIMD merge list entries that have been already present in the merge list.

In some embodiments, after adding the TIMD merge list entries associated with the TIMD information of the temporal positions or the shifted temporal positions in the collocated picture to the TIMD merge list (i.e., after step 1604 or 1606), method 1600 further includes step 1610. At step 1610, the TIMD merge list entries in the TIMD merge list are sorted based on the SATD cost over the template of the current block to have a final TIMD merge list.

In some embodiments, after coding a picture, for each block coded based on TIMD mode or TIMD merge list mode, the TIMD information of a temporal position or a shifted temporal position in the collocated picture position is stored. Then, a look up table is constructed to map each of the temporal positions and the shifted temporal positions to corresponding TIMD information. Therefore, temporal positions and shifted temporal positions in the collocated picture can be mapped to corresponding TIMD information, thereby easily for retrieving.

In some embodiments, there is no restricting of the number of the TIMD merge list entries in the TIMD merge list. For example, all the temporal positions and shifted temporal positions are checked. If there is a TIMD merge list entry which satisfied the redundancy check it is added into the TIMD merge list; otherwise, the TIMD merge list entry is discarded.

In some embodiments, the number of the TIMD merge list entries is not greater than a preset value. For example, the number of the TIMD merge list entries is restricted to not greater than M. After adding the first set of TIMD merge list entries, if the number of the TIMD merge list entries in the TIMD merge list is less than M, the second set of TIMD merge list entries is further added in the inclusion order until the number of the TIMD merge list entries in the TIMD merge list is equal to M. If the number of the first set of TIMD merge list entries in the TIMD merge list is equal or greater than M, the second set of TIMD merge list entries is not added. In some embodiments, M is in a range of 2 to 6, for example, M is 2, 4, or 6.

In some embodiments, the flag indicates whether the TIMD merge list mode is applied to the current block is conditionally signaled if at least one of the adjacent blocks, non-adjacent blocks, and temporal positions are coded based on TIMD mode or TIMD merge list mode. In another example, the flag indicates whether the TIMD merge list mode is applied to the current block is conditional signaled if at least one of the adjacent blocks, non-adjacent blocks, temporal positions, and shifted temporal positions is coded based on TIMD mode or TIMD merge list mode.

In some embodiments, after coding a picture, for each block coded based on TIMD mode or TIMD merge list mode, the TIMD information (e.g., prediction mode and the fusion weights) and the position of a corresponding block (i.e., the top-left position the block) are saved. Then, a look up table is constructed to map each of the temporal positions or the shifted temporal positions to corresponding TIMD information and a block. So that temporal positions and shifted temporal positions in the collocated picture can be mapped to corresponding TIMD information and a block. In some embodiments, a block list is constructed. First, all the adjacent blocks, non-adjacent blocks, temporal positions, and shifted temporal positions are scanned. If the scanned block or position is coded based on TIMD mode or TIMD merge list mode, the block or the position is added to a block list. In some embodiments, if two or more temporal positions or shifted temporal positions are from one block, only one position is added to the block list. Then, all the blocks and positions in the block list are sorted based on the block distance. For a temporal position or a shifted temporal position, the corresponding block position is used to calculate the block distance.

According to exemplary embodiments consistent with the present disclosure, when the DIMD merge mode is applied, the histogram information from blocks coded by DIMD mode or DIMD merge mode in the collocated picture can be considered in building the MHoG.

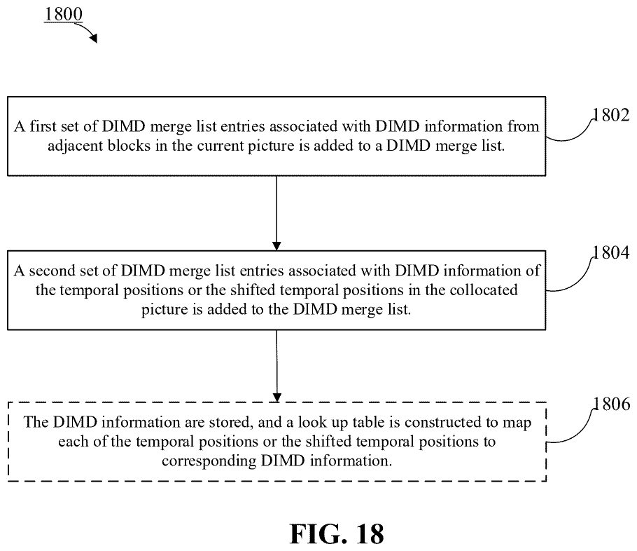

FIG. 17 illustrates a flow chart showing an example method using information of blocks in collocated picture for DIMD merge mode, according to some embodiments of the present disclosure. Method 1700 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1700. In some embodiments, method 1700 can be implemented by a computer program product, embodied in a computer-readable medium, including computer-executable instructions, such as program code, executed by computers (e.g., apparatus 400 of FIG. 4). Referring to FIG. 17, method 1700 may include the following steps 1702 to 1706.

At step 1702, first frequency-distribution information for each block coded by DIMD mode or DIMD merge mode is stored. The frequency-distribution information includes amplitude values and corresponding angular modes. For example, when the block is coded using DIMD mode or DIMD merge mode, the corresponding HoG or MHoG is saved as the first frequency-distribution information.

At step 1704, frequency-distribution information of gradients for the current DIMD merge mode coded block is constructed using the first frequency-distribution information from temporal positions or shifted temporal positions in the collocated picture.

In some embodiments, after step 1702, method 1700 further includes step 1703, At step 1703, second frequency-distribution information for each block coded based on at least one traditional intra prediction mode is stored. The intra prediction mode including at least one traditional intra prediction mode may include an angular mode, SGPM mode, or TIMD mode, etc. For example, when the block is coded using one angular mode, the angular mode and the size of the block are saved as the second frequency-distribution information. When the block is coded using SGPM or TIMD where more than one angular intra prediction modes are used to predict the block, all of the angular modes and the size of the block are saved as the second frequency-distribution information. And at step 1704, frequency-distribution information of gradients for the current DIMD merge mode coded block is constructed using the first frequency-distribution information and the second frequency-distribution information from temporal positions or shifted temporal positions in the collocated picture.

In some embodiments, if two or more temporal positions or shifted temporal positions are from one block, only one position is considered. For example, whether two or more of the temporal positions or the shifted temporal positions being from one block is determined. If the two or more of the temporal positions or the shifted temporal positions are from one block, only the frequency-distribution information associated with one of the two or more positions is stored.

In some embodiments, after step 1704, the method further includes step 1706. At step 1706, a look up table is constructed to map each of the temporal positions or the shifted temporal positions to corresponding frequency-distribution information. Therefore, temporal positions and shifted temporal positions in the collocated picture can be mapped to corresponding frequency-distribution information, thereby easily for retrieving.

According to exemplary embodiments consistent with the present disclosure, when the DIMD merge list mode is applied, DIMD merge list entries associated with DIMD information of temporal positions or shifted temporal positions in the collocated picture can be added to the DIMD merge list.

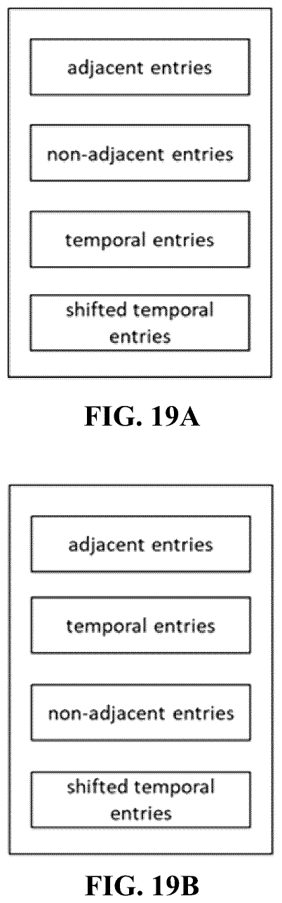

FIG. 18 illustrates a flow chart showing an example method using information of blocks in collocated picture for DIMD merge list mode, according to some embodiments of the present disclosure. Method 1800 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1800. In some embodiments, method 1800 can be implemented by a computer program product, embodied in a computer-readable medium, including computer-executable instructions, such as program code, executed by computers (e.g., apparatus 400 of FIG. 4). Referring to FIG. 18, method 1800 may include the following steps 1802 and 1804.

At step 1802, a first set of DIMD merge list entries associated with DIMD information from adjacent blocks in the current picture is added to a DIMD merge list. The DIMD information includes the prediction modes and their weights for a block. In some embodiments, a set of DIMD merge list entries associated with DIMD information from non-adjacent blocks in the current picture is also added to the DIMD merge list.

At step 1804, a second set of DIMD merge list entries associated with DIMD information of the temporal positions or the shifted temporal positions in the collocated picture is added to the DIMD merge list. In some embodiments, only the DIMD merge list entries associated with DIMD information of the temporal positions are added and the DIMD merge list entries associated with DIMD information of the shifted temporal positions are not added to the DIMD merge list. In some embodiments, there is no restriction to the number of the DIMD merge list entries in the DIMD merge list. In some embodiments, the number of the DIMD merge list entries in the DIMD merge list is restricted to be not greater than a preset number.

In some embodiments, after coding a picture, for each block coded based on the DIMD mode or the DIMD merge list mode, method 1800 further includes step 1806. At step 1806, the DIMD information are stored, and a look up table is constructed to map each of the temporal positions or the shifted temporal positions to corresponding DIMD information.

Therefore, temporal positions and shifted temporal positions in the collocated picture can be mapped to corresponding DIMD information, thereby easily for retrieving.

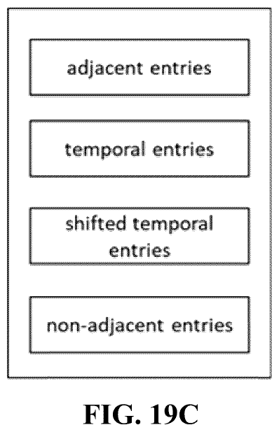

FIGS. 19A to 19C are schematic diagrams illustrating inclusion orders of entries in a DIMD merge list, according to some embodiments of the present disclosure. In some embodiments, the inclusion order of the entries in the DIMD merge list can be modified. As shown in FIG. 19A, in one example, the order is {adjacent entries, non-adjacent entries, temporal entries, shifted temporal entries}. The adjacent entries represent DIMD merge list entries from the adjacent blocks, the non-adjacent entries represent DIMD merge list entries from the non-adjacent blocks, the temporal entries represent DIMD merge list entries of the temporal positions, and shifted temporal entries represent DIMD merge list entries of the shifted temporal positions. In one example, the inclusion order is {adjacent entries, temporal entries, non-adjacent entries, shifted temporal entries} as shown in FIG. 19B. In another example, the inclusion order is {adjacent entries, temporal entries, shifted temporal entries, non-adjacent entries} as shown in FIG. 19C.

In some embodiments, the second set of DIMD merge list entries (e.g., temporal entries, shifted temporal entries) is only added to the DIMD merge list and not used in constructing the MHoG of the DIMD merge mode. In another example, the second set of DIMD merge list entries (e.g., temporal entries, shifted temporal entries) is added to the DIMD merge list and also used in constructing the MHoG of the DIMD merge mode.

According to exemplary embodiments consistent with the present disclosure, when the OBIC mode is applied, the blocks (e.g., positions) in the collocated pictures are checked and the intra prediction modes of the blocks are collected into the occurrence histogram.

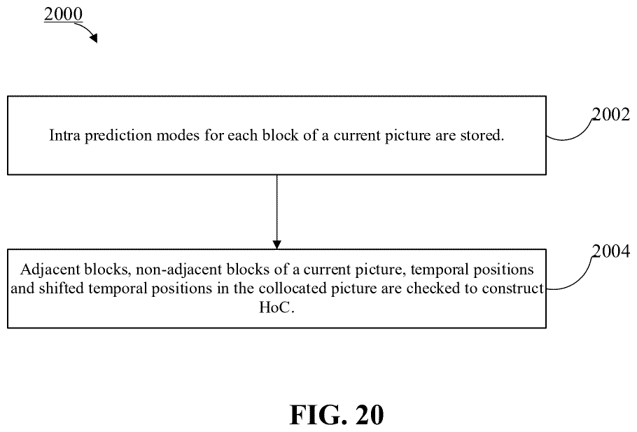

FIG. 20 illustrates a flow chart showing an example method using information of blocks in collocated picture for OBIC mode, according to some embodiments of the present disclosure. Method 2000 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 2000. In some embodiments, method 2000 can be implemented by a computer program product, embodied in a computer-readable medium, including computer-executable instructions, such as program code, executed by computers (e.g., apparatus 400 of FIG. 4). Referring to FIG. 20, method 2000 may include the following steps 2002 and 2004.

At step 2002, intra prediction modes for each block of a current picture are stored. For example, for each block coded based on at least one traditional intra prediction mode, all the traditional intra prediction modes used for prediction of the picture are stored. For example, if a block is coded by a traditional intra prediction mode, the traditional intra prediction mode is stored. If a block is coded by a DIMD mode, a DIMD merge mode, a spatial geometric partition mode (SGPM), or a TIMD mode, etc., all the traditional intra prediction modes used in predicting the block is stored.

At step 2004, adjacent blocks, non-adjacent blocks of a current picture, temporal positions and shifted temporal positions in the collocated picture are checked to construct HoC. The HoC includes the intra modes and their sample-wise occurrences.

According to exemplary embodiments consistent with the present disclosure, when MPM is applied, blocks in the collocated pictures are checked and the intra prediction modes of the blocks are considered in constructing the MPM list.

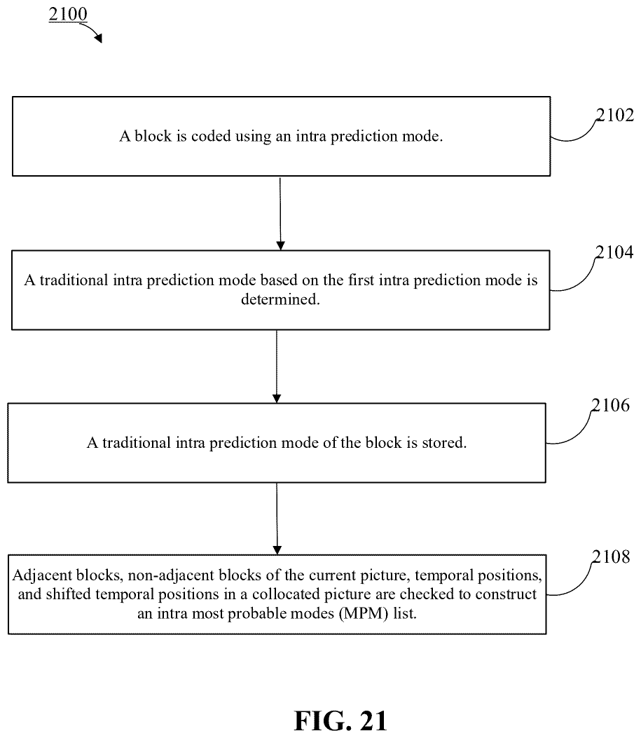

FIG. 21 illustrates a flow chart showing an example method using information of blocks in collocated picture for MPM, according to some embodiments of the present disclosure. Method 2100 can be performed by an encoder (e.g., by process 200A of FIG. 2A or 200B of FIG. 2B), a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 2100. In some embodiments, method 2100 can be implemented by a computer program product, embodied in a computer-readable medium, including computer-executable instructions, such as program code, executed by computers (e.g., apparatus 400 of FIG. 4). Referring to FIG. 21, method 2100 may include the following steps 2102 to 2106.

At step 2102, a block is coded using an intra prediction mode. The intra prediction mode can be a traditional intra prediction mode or a non-traditional intra prediction mode. For a block is coded using traditional prediction mode, for example, planar mode, DC mode, or angular modes, only one traditional mode is used to predict the current block. For a block coded using non-traditional prediction mode, for example, by DIMD mode, SGPM mode or TIMD mode, more than one traditional mode may be used to predict the current block.

At step 2104, a traditional intra prediction mode is determined based on the first intra prediction mode. The traditional intra prediction mode includes planar mode, DC mode, and angular modes. If the block is coded using a traditional intra prediction mode, the used traditional intra prediction mode is determined. If the block is coded using a non-traditional intra prediction mode, one traditional intra prediction mode is determined. In some embodiments, the determined traditional intra prediction mode is the first one of a plurality traditional intra modes. In some embodiments, the determined traditional intra prediction mode is the traditional intra modes with a largest weight. In some embodiments, the determined traditional intra prediction mode is a fixed mode, for example, the planar mode.

At step 2106, the determined traditional intra prediction mode of the block is stored.

At step 2108, adjacent blocks, non-adjacent blocks of the current picture, temporal positions, and shifted temporal positions in a collocated picture are checked to construct an intra most probable modes (MPM) list.

The embodiments described in the present disclosure can be freely combined.

In some embodiments, a non-transitory computer-readable storage medium storing a bitstream is also provided. The bitstream can be encoded and decoded according to the disclosed methods using information of blocks in collocated picture.

The embodiments may further be described using the following clauses:

1. A method of encoding a video sequence into a bitstream, the method comprising:
receiving a video sequence;
encoding one or more pictures of the video sequence, wherein the encoding comprises:
   obtaining temporal information for an intra prediction mode from an encoded picture; and
   encoding a current block based on the temporal information, wherein the temporal information associated with one or more positions in the encoded picture; and
generating a bitstream based on the encoding.

2. The method according to clause 1, wherein the encoded picture is a collocated picture of the current block.

3. The method according to clause 1, wherein the one or more positions in the encoded picture comprise temporal positions or shifted temporal positions, one shifted temporal position is obtained by shifting one temporal position with an adjacent motion vector.

4. The method according to clause 3, wherein the intra prediction mode comprises at least one of:
a template-based intra mode derivation (TIMD) merge list mode;
a decoder side intra mode derivation (DIMD) merge mode;
an DIMD merge list mode;
an occurrence-based intra coding (OBIC) mode; or
a most probable mode (MPM).

5. The method according to clause 4, wherein the intra prediction mode is the TIMD merge list mode, the method further comprises:
adding a first set of TIMD merge list entries associated with TIMD information from adjacent blocks in a current picture to a TIMD merge list; and
adding a second set of TIMD merge list entries associated with TIMD information of the temporal positions in the encoded picture to the TIMD merge list.

6. The method according to clause 5, further comprising:
adding a third set of TIMD merge list entries associated with TIMD information of the shifted temporal positions in the encoded picture to the TIMD merge list.

7. The method according to clause 5, further comprising:
performing a redundancy check on the TIMD merge list.

8. The method according to clause 5, further comprising:
sorting the TIMD merge list entries in the TIMD merge list based on a sum of absolute transformed difference (SATD) cost over a template of the current block.

9. The method according to clause 5, further comprising:
storing the TIMD information associated with the temporal positions in the encoded picture and the TIMD information associated with the shifted temporal positions in the encoded picture; and
constructing a look up table to map each of the temporal positions and the shifted temporal positions to corresponding TIMD information.

10. The method according to clause 6, wherein a number of the TIMD merge list entries is not greater than a preset value.

11. The method according to clause 4, further comprising:
encoding a flag indicating whether the TIMD merge mode is applied to the current block, wherein
when at least one of the adjacent blocks, non-adjacent blocks, the temporal positions, or the shifted temporal positions are coded based on the TIMD mode or the TIMD merge list mode, the flag indicates that the TIMD merge mode is being applied to the current block.

12. The method according to clause 5, further comprising:
storing the TIMD information and a position of a block; and
constructing a look up table to map each of the temporal positions and the shifted temporal positions to corresponding TIMD information and the position of the block.

13. The method according to clause 11, further comprising:
scanning the adjacent blocks, the non-adjacent blocks, the temporal positions, and the shifted temporal positions;
determining whether the adjacent blocks, the non-adjacent blocks, the temporal positions, or the shifted temporal positions is coded based on the TIMD mode or the TIMD merge list mode;
adding an adjacent block, a non-adjacent block, a temporal position, or a shifted temporal position to a block list, when the adjacent block, the non-adjacent block, the temporal position, or the shifted temporal position is coded based on the TIMD mode or the TIMD merge list mode; and
sorting the adjacent blocks, the non-adjacent blocks, the temporal positions, or the shifted temporal positions in the block list based on a block distance.

14. The method according to clause 4, wherein the intra prediction mode is the DIMD merge mode, the method further comprises:
storing first frequency-distribution information for each block coded based on a first intra prediction mode associated with the temporal positions or the shifted temporal positions in the encoded picture; and
constructing frequency-distribution of gradients for the current block using the first frequency-distribution information.

15. The method according to clause 4, wherein the intra prediction mode is the DIMD merge mode, the method further comprises:
storing first frequency-distribution information for each block coded based on a first intra prediction mode associated with the temporal positions or the shifted temporal positions in the encoded picture;
storing second frequency-distribution information for each block coded based on a second intra prediction mode associated with the temporal positions or the shifted temporal positions in the encoded picture; and
constructing frequency-distribution of gradients for the current block using the first frequency-distribution information and the second frequency-distribution information.

16. The method according to clause 14 or 15, wherein the first intra prediction mode comprises the DIMD mode, and a DIMD merge mode.

17. The method according to clause 15, wherein the second intra prediction mode comprises a traditional intra prediction mode, a DIMD mode, a DIMD merge mode, a spatial geometric partition mode (SGPM), or the TIMD mode.

18. The method according to clause 14 or 15, wherein corresponding histogram of gradients (HoG) or merged histogram of gradients (MHoG) of the block is saved as the first frequency-distribution information.

19. The method according to clause 15, wherein
when a block is coded using one angular mode, the angular mode and a size of the block are saved as the second frequency-distribution information; and
when a block is coded using spatial geometric partition mode (SGPM) or the TIMD, all angular modes and a size of the block are saved as the second frequency-distribution information.

20. The method according to clause 14 or 15, further comprising:
determining whether two or more of the temporal positions or the shifted temporal positions being from one block; and
when the two or more of the temporal positions or the shifted temporal positions are from one block, storing frequency-distribution information associated with one of the two or more positions as the first or the second frequency-distribution information.

21. The method according to clause 14 or 15, wherein:
constructing a look up table to map each of the temporal positions or the shifted temporal positions to corresponding frequency-distribution information.

22. The method according to claim 4, wherein the intra prediction mode is the DIMD merge mode, the method further comprises:
adding a first set of DIMD merge list entries associated with DIMD information from adjacent blocks and non-adjacent blocks in a current picture to a DIMD merge list; and
adding a second set of DIMD merge list entries associated with DIMD information of the temporal positions or the shifted temporal positions in the encoded picture to the DIMD merge list.

23. The method according to clause 22, further comprising:
storing the DIMD information of the temporal positions and the shifted temporal positions in the encoded picture; and
constructing a look up table to map each of the temporal positions and the shifted temporal positions to corresponding DIMD information.

24. The method according to clause 22, wherein an inclusion order of the DIMD merge list entries is selected from one of:
{DIMD merge list entries from the adjacent blocks, DIMD merge list entries of the temporal positions, DIMD merge list entries from the non-adjacent blocks, and DIMD merge list entries of the shifted temporal positions};
{DIMD merge list entries from the adjacent blocks, DIMD merge list entries from the non-adjacent blocks, DIMD merge list entries of the temporal positions, and DIMD merge list entries of the shifted temporal positions}; or
{DIMD merge list entries from the adjacent blocks, DIMD merge list entries of the temporal positions, DIMD merge list entries of the shifted temporal positions; and DIMD merge list entries from the non-adjacent blocks}.

25. The method according to clause 4, wherein the intra prediction mode is the OBIC mode, the method further comprises:
storing intra prediction modes for each block of a current picture; and
constructing histogram of occurrence (HoC) by checking adjacent blocks, non-adjacent blocks of a current picture, the temporal positions and the shifted temporal positions in the encoded picture.

26. The method according to clause 4, wherein the intra prediction mode is the MPM, the method further comprises:
encoding a block using a first intra prediction mode;
determine a traditional intra prediction mode based on the first intra prediction mode;
storing the traditional intra prediction mode; and
constructing an intra most probable modes list by checking adjacent blocks, non-adjacent blocks of a current picture, the temporal positions and the shifted temporal positions in the encoded picture.

27. A method of decoding a bitstream to output one or more pictures for a video stream, the method comprising:
receiving a bitstream; and
decoding, using coded information of the bitstream, one or more pictures, wherein the decoding comprises:
obtaining temporal information for an intra prediction mode from an encoded picture; and
decoding a current block based on the temporal information, wherein the temporal information associated with one or more positions in the encoded picture.

28. The method according to clause 27, wherein the encoded picture is a collocated picture of the current block.

29. The method according to clause 27, wherein the one or more positions in the encoded picture comprise temporal positions or shifted temporal positions, one shifted temporal position is obtained by shifting one temporal position with an adjacent motion vector.

30. The method according to clause 29, wherein the intra prediction mode comprises at least one of:
a template-based intra mode derivation (TIMD) merge list mode;
a decoder side intra mode derivation (DIMD) merge mode;
an DIMD merge list mode;
an occurrence-based intra coding (OBIC) mode; or
a most probable mode (MPM).

31. The method according to clause 30, wherein the intra prediction mode is the TIMD merge list mode, the method further comprises:
adding a first set of TIMD merge list entries associated with TIMD information from adjacent blocks in a current picture to a TIMD merge list; and
adding a second set of TIMD merge list entries associated with TIMD information of the temporal positions in the encoded picture to the TIMD merge list.

32. The method according to clause 31, further comprising:
adding a third set of TIMD merge list entries associated with TIMD information of the shifted temporal positions in the encoded picture to the TIMD merge list.

33. The method according to clause 31, further comprising:
performing a redundancy check on the TIMD merge list.

34. The method according to clause 31, further comprising:
sorting the TIMD merge list entries in the TIMD merge list based on a sum of absolute transformed difference (SATD) cost over a template of the current block.

35. The method according to clause 31, further comprising:
storing the TIMD information associated with the temporal positions in the encoded picture and the TIMD information associated with the shifted temporal positions in the encoded picture; and
constructing a look up table to map each of the temporal positions and the shifted temporal positions to corresponding TIMD information.

36. The method according to clause 32, wherein a number of the TIMD merge list entries is not greater than a preset value.

37. The method according to clause 30, further comprising:
decoding a flag indicating whether the TIMD merge mode is applied to the current block, wherein when at least one of the adjacent blocks, non-adjacent blocks, the temporal positions, or the shifted temporal positions are coded based on the TIMD mode or the TIMD merge list mode, the flag indicates that the TIMD merge mode is being applied to the current block.

38. The method according to clause 31, further comprising:
storing the TIMD information and a position of a block; and
constructing a look up table to map each of the temporal positions and the shifted temporal positions to corresponding TIMD information and the position of the block.

39. The method according to clause 37, further comprising:
scanning the adjacent blocks, the non-adjacent blocks, the temporal positions, and the shifted temporal positions;
determining whether the adjacent blocks, the non-adjacent blocks, the temporal positions, or the shifted temporal positions is coded based on the TIMD mode or the TIMD merge list mode;
adding an adjacent block, a non-adjacent block, a temporal position, or a shifted temporal position to a block list, when the adjacent block, the non-adjacent block, the temporal position, or the shifted temporal position is coded based on the TIMD mode or the TIMD merge list mode; and
sorting the adjacent blocks, the non-adjacent blocks, the temporal positions, or the shifted temporal positions in the block list based on a block distance.

40. The method according to clause 30, wherein the intra prediction mode is the DIMD merge mode, the method further comprises:
storing first frequency-distribution information for each block coded based on a first intra prediction mode associated with the temporal positions or the shifted temporal positions in the encoded picture; and
constructing frequency-distribution of gradients for the current block using the first frequency-distribution information.

41. The method according to clause 30, wherein the intra prediction mode is the DIMD merge mode, the method further comprises:
storing first frequency-distribution information for each block coded based on a first intra prediction mode associated with the temporal positions or the shifted temporal positions in the encoded picture;
storing second frequency-distribution information for each block coded based on a second intra prediction mode associated with the temporal positions or the shifted temporal positions in the encoded picture; and
constructing frequency-distribution of gradients for the current block using the first frequency-distribution information and the second frequency-distribution information.

42. The method according to clause 40 or 41, wherein the first intra prediction mode comprises the DIMD mode, and a DIMD merge mode.

43. The method according to clause 15, wherein the second intra prediction mode comprises a traditional intra prediction mode, a DIMD mode, a DIMD merge mode, a spatial geometric partition mode (SGPM), or the TIMD mode.

44. The method according to clause 40 or 41, wherein corresponding histogram of gradients (HoG) or merged histogram of gradients (MHoG) of the block is saved as the first frequency-distribution information.

45. The method according to clause 41, wherein when a block is coded using one angular mode, the angular mode and a size of the block are saved as the second frequency-distribution information; and when a block is coded using spatial geometric partition mode (SGPM) or the TIMD, all angular modes and a size of the block are saved as the second frequency-distribution information.

46. The method according to clause 40 or 41, further comprising:
determining whether two or more of the temporal positions or the shifted temporal positions being from one block; and
when the two or more of the temporal positions or the shifted temporal positions are from one block, storing frequency-distribution information associated with one of the two or more positions as the first or the second frequency-distribution information.

47. The method according to clause 40 or 41, wherein:

constructing a look up table to map each of the temporal positions or the shifted temporal positions to corresponding frequency-distribution information.

48. The method according to claim 30, wherein the intra prediction mode is the DIMD merge mode, the method further comprises:
adding a first set of DIMD merge list entries associated with DIMD information from adjacent blocks and non-adjacent blocks in a current picture to a DIMD merge list; and
adding a second set of DIMD merge list entries associated with DIMD information of the temporal positions or the shifted temporal positions in the encoded picture to the DIMD merge list.

49. The method according to clause 48, further comprising:
storing the DIMD information of the temporal positions and the shifted temporal positions in the encoded picture; and constructing a look up table to map each of the temporal positions and the shifted temporal positions to corresponding DIMD information.

50. The method according to clause 48, wherein an inclusion order of the DIMD merge list entries is selected from one of:
{DIMD merge list entries from the adjacent blocks, DIMD merge list entries of the temporal positions, DIMD merge list entries from the non-adjacent blocks, and DIMD merge list entries of the shifted temporal positions};
{DIMD merge list entries from the adjacent blocks, DIMD merge list entries from the non-adjacent blocks, DIMD merge list entries of the temporal positions, and DIMD merge list entries of the shifted temporal positions}; or
{DIMD merge list entries from the adjacent blocks, DIMD merge list entries of the temporal positions, DIMD merge list entries of the shifted temporal positions; and DIMD merge list entries from the non-adjacent blocks}.

51. The method according to clause 30, wherein the intra prediction mode is the OBIC mode, the method further comprises:
storing intra prediction modes for each block of a current picture; and
constructing histogram of occurrence (HoC) by checking adjacent blocks, non-adjacent blocks of a current picture, the temporal positions and the shifted temporal positions in the encoded picture.

52. The method according to clause 30, wherein the intra prediction mode is the MPM, the method further comprises:
decoding a block using a first intra prediction mode;
determine a traditional intra prediction mode based on the first intra prediction mode;
storing the traditional intra prediction mode; and
constructing an intra most probable modes list by checking adjacent blocks, non-adjacent blocks of a current picture, the temporal positions and the shifted temporal positions in the encoded picture.

53. A non-transitory computer readable storage medium storing a set of instructions that are executable by one or more processors of a system to cause the system to perform operations for generating a bitstream, the operations comprising:

receiving a video sequence;

encoding one or more pictures of the video sequence by:
obtaining temporal information for an intra prediction mode from an encoded picture, and encoding a current block based on the temporal information, wherein the temporal information associated with one or more positions in the encoded picture; and generating a bitstream based on the encoding.

54. The non-transitory computer readable storage medium according to clause 53, wherein the encoded picture is a collocated picture of the current block.

55. The non-transitory computer readable storage medium according to clause 53, wherein the one or more positions in the encoded picture comprise temporal positions or shifted temporal positions, one shifted temporal position is obtained by shifting one temporal position with an adjacent motion vector.

56. The non-transitory computer readable storage medium according to clause 55, wherein the intra prediction mode comprises at least one of:
a template-based intra mode derivation (TIMD) merge list mode;
a decoder side intra mode derivation (DIMD) merge mode;
an DIMD merge list mode;
an occurrence-based intra coding (OBIC) mode; or a most probable mode (MPM).

57. The non-transitory computer readable storage medium according to clause 56, wherein the intra prediction mode is the TIMD merge list mode, the method further comprises:
adding a first set of TIMD merge list entries associated with TIMD information from adjacent blocks in a current picture to a TIMD merge list; and
adding a second set of TIMD merge list entries associated with TIMD information of the temporal positions in the encoded picture to the TIMD merge list.

58. The non-transitory computer readable storage medium according to clause 57, wherein the operations further comprise:
adding a third set of TIMD merge list entries associated with TIMD information of the shifted temporal positions in the encoded picture to the TIMD merge list.

59. The non-transitory computer readable storage medium according to clause 57, wherein the operations further comprise:
performing a redundancy check on the TIMD merge list.

60. The non-transitory computer readable storage medium according to clause 57, wherein the operations further comprise:
sorting the TIMD merge list entries in the TIMD merge list based on a sum of absolute transformed difference (SATD) cost over a template of the current block.

61. The non-transitory computer readable storage medium according to clause 57, wherein the operations further comprise:
storing the TIMD information associated with the temporal positions in the encoded picture and the TIMD information associated with the shifted temporal positions in the encoded picture; and
constructing a look up table to map each of the temporal positions and the shifted temporal positions to corresponding TIMD information.

62. The non-transitory computer readable storage medium according to clause 58, wherein a number of the TIMD merge list entries is not greater than a preset value.

63. The non-transitory computer readable storage medium according to clause 56, wherein the operations further comprise:
encoding a flag indicating whether the TIMD merge mode is applied to the current block, wherein
when at least one of the adjacent blocks, non-adjacent blocks, the temporal positions, or the shifted temporal positions are coded based on the TIMD mode or the TIMD merge list mode, the flag indicates that the TIMD merge mode is being applied to the current block.

64. The non-transitory computer readable storage medium according to clause 57, wherein the operations further comprise:
storing the TIMD information and a position of a block; and
constructing a look up table to map each of the temporal positions and the shifted temporal positions to corresponding TIMD information and the position of the block.

65. The non-transitory computer readable storage medium according to clause 63, wherein the operations further comprise:
scanning the adjacent blocks, the non-adjacent blocks, the temporal positions, and the shifted temporal positions;
determining whether the adjacent blocks, the non-adjacent blocks, the temporal positions, or the shifted temporal positions is coded based on the TIMD mode or the TIMD merge list mode;
adding an adjacent block, a non-adjacent block, a temporal position, or a shifted temporal position to a block list, when the adjacent block, the non-adjacent block, the temporal position, or the shifted temporal position is coded based on the TIMD mode or the TIMD merge list mode; and
sorting the adjacent blocks, the non-adjacent blocks, the temporal positions, or the shifted temporal positions in the block list based on a block distance.

66. The non-transitory computer readable storage medium according to clause 56, wherein the intra prediction mode is the DIMD merge mode, the method further comprises:
storing first frequency-distribution information for each block coded based on a first intra prediction mode associated with the temporal positions or the shifted temporal positions in the encoded picture; and
constructing frequency-distribution of gradients for the current block using the first frequency-distribution information.

67. The non-transitory computer readable storage medium according to clause 56, wherein the intra prediction mode is the DIMD merge mode, the method further comprises:
storing first frequency-distribution information for each block coded based on a first intra prediction mode associated with the temporal positions or the shifted temporal positions in the encoded picture;
storing second frequency-distribution information for each block coded based on a second intra prediction mode associated with the temporal positions or the shifted temporal positions in the encoded picture; and
constructing frequency-distribution of gradients for the current block using the first frequency-distribution information and the second frequency-distribution information.

68. The non-transitory computer readable storage medium according to clause 66 or 67, wherein the first intra prediction mode comprises the DIMD mode, and a DIMD merge mode.

69. The non-transitory computer readable storage medium according to clause 67, wherein the second intra prediction mode comprises a traditional intra prediction mode, a DIMD mode, a DIMD merge mode, a spatial geometric partition mode (SGPM), or the TIMD mode.

70. The non-transitory computer readable storage medium according to clause 66 or 67, wherein corresponding histogram of gradients (HoG) or merged histogram of gradients (MHoG) of the block is saved as the first frequency-distribution information.

71. The non-transitory computer readable storage medium according to clause 67, wherein
when a block is coded using one angular mode, the angular mode and a size of the block are saved as the second frequency-distribution information; and
when a block is coded using spatial geometric partition mode (SGPM) or the TIMD, all angular modes and a size of the block are saved as the second frequency-distribution information.

72. The non-transitory computer readable storage medium according to clause 66 or 67, wherein the operations further comprise:
determining whether two or more of the temporal positions or the shifted temporal positions being from one block; and
when the two or more of the temporal positions or the shifted temporal positions are from one block, storing frequency-distribution information associated with one of the two or more positions as the first or the second frequency-distribution information.

73. The non-transitory computer readable storage medium according to clause 66 or 67, wherein:
constructing a look up table to map each of the temporal positions or the shifted temporal positions to corresponding frequency-distribution information.

74. The non-transitory computer readable storage medium according to claim 56, wherein the intra prediction mode is the DIMD merge mode, the operations further comprise:
adding a first set of DIMD merge list entries associated with DIMD information from adjacent blocks and non-adjacent blocks in a current picture to a DIMD merge list; and
adding a second set of DIMD merge list entries associated with DIMD information of the temporal positions or the shifted temporal positions in the encoded picture to the DIMD merge list.

75. The non-transitory computer readable storage medium according to clause 74, wherein the operations further comprise:
storing the DIMD information of the temporal positions and the shifted temporal positions in the encoded picture; and
constructing a look up table to map each of the temporal positions and the shifted temporal positions to corresponding DIMD information.

76. The non-transitory computer readable storage medium according to clause 74, wherein an inclusion order of the DIMD merge list entries is selected from one of:
{DIMD merge list entries from the adjacent blocks, DIMD merge list entries of the temporal positions, DIMD merge list entries from the non-adjacent blocks, and DIMD merge list entries of the shifted temporal positions};
{DIMD merge list entries from the adjacent blocks, DIMD merge list entries from the non-adjacent blocks, DIMD merge list entries of the temporal positions, and DIMD merge list entries of the shifted temporal positions}; or
{DIMD merge list entries from the adjacent blocks, DIMD merge list entries of the temporal positions, DIMD merge list entries of the shifted temporal positions; and DIMD merge list entries from the non-adjacent blocks}.

77. The non-transitory computer readable storage medium according to clause 56, wherein the intra prediction mode is the OBIC mode, the operations further comprise:
storing intra prediction modes for each block of a current picture; and
constructing histogram of occurrence (HoC) by checking adjacent blocks, non-adjacent blocks of a current picture, the temporal positions and the shifted temporal positions in the encoded picture.

78. The non-transitory computer readable storage medium according to clause 56, wherein the intra prediction mode is the MPM, the operations further comprise:
encoding a block using a first intra prediction mode;
determine a traditional intra prediction mode based on the first intra prediction mode;
storing the traditional intra prediction mode; and
constructing an intra most probable modes list by checking adjacent blocks, non-adjacent blocks of a current picture, the temporal positions and the shifted temporal positions in the encoded picture.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of decoding a bitstream to output one or more pictures for a video stream, the method comprising:
receiving a bitstream; and
decoding, using coded information of the bitstream, one or more pictures, wherein the decoding comprises:
obtaining temporal information for an intra prediction mode from an encoded picture; and
decoding a current block based on the temporal information, wherein the temporal information associated with one or more positions in the encoded picture.

2. The method according to claim 1, wherein the one or more positions in the encoded picture comprise temporal positions or shifted temporal positions, one shifted temporal position is obtained by shifting one temporal position with an adjacent motion vector.

3. The method according to claim 2, wherein the intra prediction mode comprises at least one of:
a template-based intra mode derivation (TIMD) merge list mode;
a decoder side intra mode derivation (DIMD) merge mode;
an DIMD merge list mode;
an occurrence-based intra coding (OBIC) mode; or
a most probable mode (MPM).

4. The method according to claim 3, wherein the intra prediction mode is the TIMD merge list mode, the method further comprises:
adding a first set of TIMD merge list entries associated with TIMD information from adjacent blocks in a current picture to a TIMD merge list; and
adding a second set of TIMD merge list entries associated with TIMD information of the temporal positions in the encoded picture to the TIMD merge list.

5. The method according to claim 3, wherein the intra prediction mode is the DIMD merge mode, the method further comprises:
storing first frequency-distribution information for each block coded based on a first intra prediction mode associated with the temporal positions or the shifted temporal positions in the encoded picture; and
constructing frequency-distribution of gradients for the current block using the first frequency-distribution information.

6. The method according to claim 3, wherein the intra prediction mode is the DIMD merge mode, the method further comprises:
adding a first set of DIMD merge list entries associated with DIMD information from adjacent blocks and non-adjacent blocks in a current picture to a DIMD merge list; and
adding a second set of DIMD merge list entries associated with DIMD information of the temporal positions or the shifted temporal positions in the encoded picture to the DIMD merge list.

7. The method according to claim 3, wherein the intra prediction mode is the OBIC mode, the method further comprises:
storing intra prediction modes for each block of a current picture; and
constructing histogram of occurrence (HoC) by checking adjacent blocks, non-adjacent blocks of a current picture, the temporal positions and the shifted temporal positions in the encoded picture.

8. The method according to claim 3, wherein the intra prediction mode is the MPM, the method further comprises:
decoding a block using a first intra prediction mode;
determine a traditional intra prediction mode based on the first intra prediction mode;
storing the traditional intra prediction mode; and
constructing an intra most probable modes list by checking adjacent blocks, non-adjacent blocks of a current picture, the temporal positions and the shifted temporal positions in the encoded picture.

9. A method of encoding a video sequence into a bitstream, the method comprising:
receiving a video sequence;
encoding one or more pictures of the video sequence, wherein the encoding comprises:
obtaining temporal information for an intra prediction mode from an encoded picture, and
encoding a current block based on the temporal information, wherein the temporal information associated with one or more positions in the encoded picture; and
generating a bitstream based on the encoding.

10. The method according to claim 9, wherein the one or more positions in the encoded picture comprise temporal positions or shifted temporal positions, one shifted temporal position is obtained by shifting one temporal position with an adjacent motion vector.

11. The method according to claim 10, wherein the intra prediction mode comprises at least one of:
a template-based intra mode derivation (TIMD) merge list mode;
a decoder side intra mode derivation (DIMD) merge mode;
an DIMD merge list mode;
an occurrence-based intra coding (OBIC) mode; or
a most probable mode (MPM).

12. The method according to claim 11, wherein the intra prediction mode is the TIMD merge list mode, the method further comprises:
adding a first set of TIMD merge list entries associated with TIMD information from adjacent blocks in a current picture to a TIMD merge list; and
adding a second set of TIMD merge list entries associated with TIMD information of the temporal positions in the encoded picture to the TIMD merge list.

13. The method according to claim 11, wherein the intra prediction mode is the DIMD merge mode, the method further comprises:
storing first frequency-distribution information for each block coded based on a first intra prediction mode associated with the temporal positions or the shifted temporal positions in the encoded picture; and
constructing frequency-distribution of gradients for the current block using the first frequency-distribution information.

14. The method according to claim 11, wherein the intra prediction mode is the DIMD merge mode, the method further comprises:
adding a first set of DIMD merge list entries associated with DIMD information from adjacent blocks and non-adjacent blocks in a current picture to a DIMD merge list; and
adding a second set of DIMD merge list entries associated with DIMD information of the temporal positions or the shifted temporal positions in the encoded picture to the DIMD merge list.

15. The method according to claim 11, wherein the intra prediction mode is the OBIC mode, the method further comprises:
storing intra prediction modes for each block of a current picture; and
constructing histogram of occurrence (HoC) by checking adjacent blocks, non-adjacent blocks of a current picture, the temporal positions and the shifted temporal positions in the encoded picture.

16. The method according to claim 11, wherein the intra prediction mode is the MPM, the method further comprises:
decoding a block using a first intra prediction mode;
determine a traditional intra prediction mode based on the first intra prediction mode;
storing the traditional intra prediction mode; and
constructing an intra most probable modes list by checking adjacent blocks, non-adjacent blocks of a current picture, the temporal positions and the shifted temporal positions in the encoded picture.

17. A non-transitory computer readable storage medium storing a set of instructions that are executable by one or more processors of a system to cause the system to perform operations for generating a bitstream, the operations comprising:
receiving a video sequence;
encoding one or more pictures of the video sequence by:
obtaining temporal information for an intra prediction mode from an encoded picture; and
encoding a current block based on the temporal information, wherein the temporal information associated with one or more positions in the encoded picture; and
generating a bitstream based on the encoding.

18. The non-transitory computer readable storage medium according to claim 17, wherein the one or more positions in the encoded picture comprise temporal positions or shifted temporal positions, one shifted temporal position is obtained by shifting one temporal position with an adjacent motion vector.

19. The non-transitory computer readable storage medium according to claim 18, wherein the intra prediction mode comprises at least one of:
a template-based intra mode derivation (TIMD) merge list mode;
a decoder side intra mode derivation (DIMD) merge mode;
an DIMD merge list mode;
an occurrence-based intra coding (OBIC) mode; or
a most probable mode (MPM).

20. The non-transitory computer readable storage medium according to claim 17, wherein the encoded picture is a collocated picture of the current block.
